(19) United States
(12) Patent Application Publication
(10) Pub. No.: US 2002/0078135 A1
(43) Pub. Date: Jun. 20, 2002

(54) Method and apparatus for improving the operation of an application layer proxy

(75) Inventor: Venkat Venkatsubra, Austin, TX (US)

Correspondence Address: Duke W. Yee, Carstens, Yee & Cahoon, LLP, P.O. Box 802334, Dallas, TX, 75380, US

(73) Assignee: IBM Corporation

(21) Appl. No.: 09/810,033

(22) Filed: Mar. 15, 2001

(51) Int. Cl. G06F 15/16

(52) U.S. Cl. 709/202; 709/203

(57) ABSTRACT

An apparatus and method for improving the operation of an application layer proxy by minimizing sources of delay in moving data from one TCP/IP connection to the other are provided. The apparatus and method improve the operation of the application layer proxy by performing the movement of data packets from one TCP/IP connection to the other in the kernel of the application layer proxy. The movement of data packets is performed by moving address pointers to the data packets from a first TCP/IP connection receive buffer to a send buffer of a second TCP/IP connection. In this way, the context switching required by the prior art is eliminated and traversal of the TCP/IP stack is not necessary. Furthermore, two separate TCP connections are maintained and thus, the features used for the connections are not limited by the features supported by the end points. Features supported by the application layer proxy may be used in the TCP connections.

### BACKGROUND OF THE INVENTION

1. Technical Field

The present invention is directed to a method and apparatus for improving the operation of an application layer proxy. In particular, the present invention is directed to an apparatus and method for performing movement of data between kernel sockets of an application layer proxy.

2. Description of Related Art

Application layer proxies play an important role in today's networks serving as firewalls, Hypertext Transfer Protocol (HTTP) caches, and the like. Application proxy servers are available for common Internet services such as, for example, an HTTP proxy is used for Web access and an SMTP proxy is used for e-mail. Application layer proxies generally employ network address translation (NAT), which presents one organization-wide IP address to the Internet. The application layer proxy funnels all user requests to the Internet and fans responses back out to the appropriate users. Application layer proxies may also cache Web pages, so that the next request can be obtained locally. Thus, application layer proxies may be used to perform any of a number of different functions.

With known application layer proxies, input is received in one port and forwarded out a different port. In this way, the straight path between two networks is closed. Thus, persons wishing to hack into a private network and obtain internal addresses and details of the private network are prevented from doing so.

Current application layer proxies spend most of their processing time moving data back and forth between connections. This is referred to as context switching and involves crossing protection boundaries for each chunk of data that is handled. Thus, the application layer proxy represents a significant bottleneck for the movement of data between client devices and servers.

FIG. 1A illustrates a known split-connection application layer proxy. As shown in FIG. 1A, when a client device attempts to connect to a server, a client library intercepts the connection attempt and redirects it so that a connection is made to the proxy device. The proxy device then creates a second connection to the server thereby splitting the logical connection between the server and the client device into two logical connections. Because the logical connection between the client device and the server is split, the application layer proxy may perform its functions on the data being passed between logical connections.

In order to move data from the server to the client device, the application layer proxy reads the data intended for the client device from the proxy-server connection and writes it into the proxy-client connection. Such reading and writing requires that the data be moved through the Transmission Control Protocol/Internet Protocol (TCP/IP) stack. In other words, the data must be copied from the kernel space to the application space over one socket connection and then from the application space to the kernel space over a second socket connection.

Having to traverse the TCP/IP stack twice for each packet of data and copy the data twice, from kernel space to user space and then from user space to kernel space, becomes a source of overhead and delay in the system. In order to address this source of overhead and delay, a mechanism for splicing the two logical connections has been developed. This mechanism is described in “TCP Splicing for Application Layer Proxy Performance,” David A Maltz and Pravin Bhagwat, published in IBM Technical Report RC 21139, March 1998, which is hereby incorporated by reference. This mechanism involves forwarding TCP data packets from one connection over to the other connection by mapping TCP sequence number, acknowledgment number, and the like, in the TCP header of the data packet from one connection to the other connection. In this way, the mechanism acts as a router for routing the data packets from one connection to the other. In this solution, however, the TCP features used for the connection, i.e. Large window support, selective acknowledgment, limited transmit algorithm, explicit congestion notification, and the like, between the client and the server are limited by the features provided in the TCP/IP stack of the two end points (the client and the server).

Thus, it would be beneficial to have an apparatus and method for improving the operation of an application layer proxy such that overhead and delay is reduced and the features of the connection are not limited by the TCP/IP stack of the two end points.

### SUMMARY OF THE INVENTION

The present invention provides an apparatus and method for improving the operation of an application layer proxy by minimizing sources of delay in moving data from one TCP/IP connection to the other. The present invention improves the operation of the application layer proxy by performing the movement of data packets from one TCP/IP connection to another in the kernel of the application layer proxy. The movement of data packets is performed by moving address pointers to the data packets from a first TCP/IP connection receive buffer to a send buffer of a second TCP/IP connection. In this way, the context switching required by the prior art is eliminated and traversal of the TCP/IP stack is not necessary. Furthermore, two separate TCP connections are maintained and thus, the features used for the connections are not limited by the features supported by the end points. Features supported by the application layer proxy may be used in the TCP connections.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1A is a diagram illustrating a prior art system for transferring data packets between a client and a server using an application layer proxy apparatus;

FIG. 1B depicts a pictorial representation of a network of data processing systems in which the present invention may be implemented;

FIG. 2 is a block diagram of a data processing system that may be implemented as a server in accordance with a preferred embodiment of the present invention;

FIG. 3 is a block diagram illustrating a data processing system in which the present invention may be implemented;

FIG. 4 is an exemplary block diagram illustrating movement of data packet address pointers in accordance with the present invention; and

FIG. 5 is a flowchart outlining an exemplary operation of the present invention.

### DETAILED DESCRIPTION OF THE PREFERRED EMBODIMENT

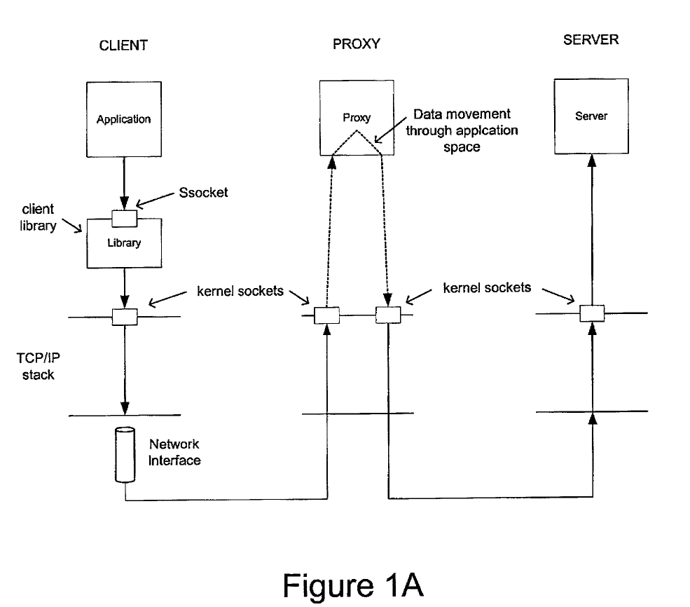

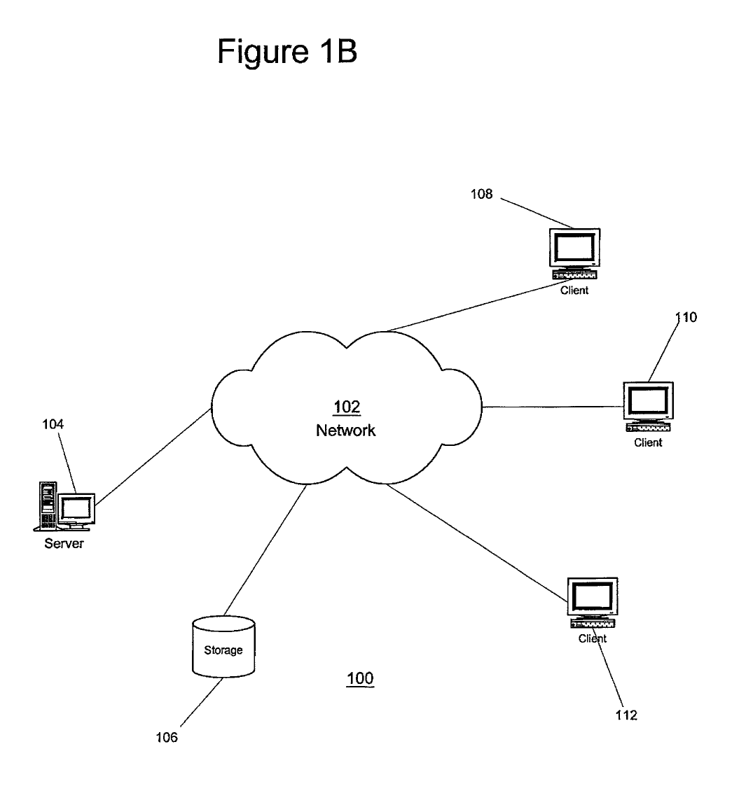

With reference now to the figures, FIG. 1B depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, a server 104 is connected to network 102 along with storage unit 106. In addition, clients 108, 110, and 112 also are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. Network data processing system 100 may include additional servers, clients, and other devices not shown.

In the depicted example, network data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1B is intended as an example, and not as an architectural limitation for the present invention.

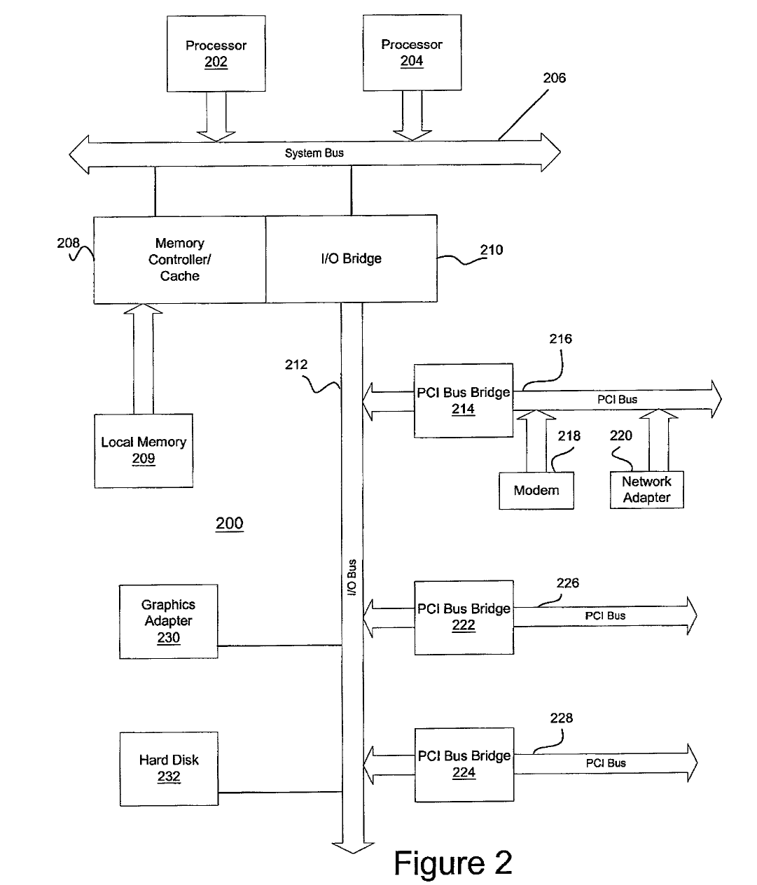

Referring to FIG. 2, a block diagram of a data processing system that may be implemented as a server, such as servers 104, 114, 118 in FIG. 1B, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI bus 216. Typical PCI bus implementations will support four PCI expansion slots or add-in connectors. Communications links to network computers 108-112 in FIG. 1B may be provided through modem 218 and network adapter 220 connected to PCI local bus 216 through add-in boards.

Additional PCI bus bridges 222 and 224 provide interfaces for additional PCI buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM RISC/System 6000 system, a product of International Business Machines Corporation in Armonk, N.Y., running the Advanced Interactive Executive (AIX) operating system.

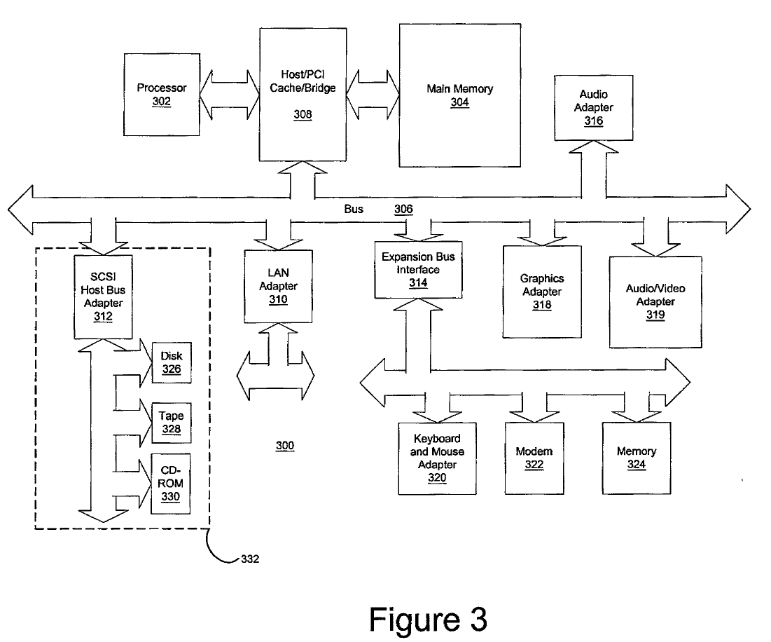

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows 2000, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interface, whether or not data processing system 300 comprises some type of network communication interface. As a further example, data processing system 300 may be a Personal Digital Assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

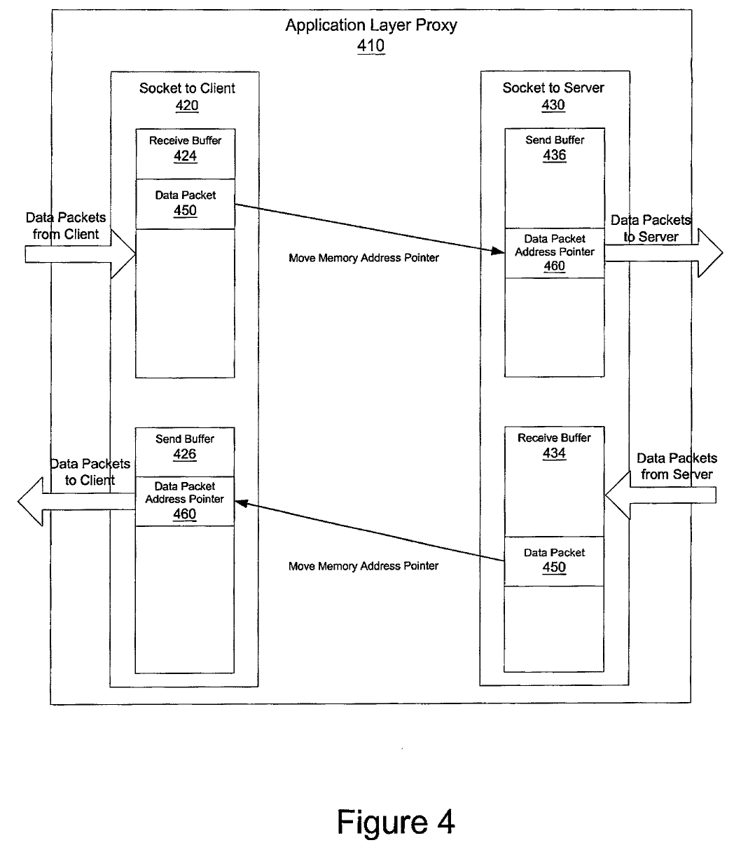

With reference now to FIG. 4, an exemplary block diagram illustrating the movement of data packets from one TCP/IP connection in an application layer proxy to another TCP/IP connection in the application layer proxy in accordance with the present invention will now be described. As described above, when a client device, such as client device 108, wishes to communicate with a server device, such as server 104, a library associated with the client device causes the communication connection establishment to be rerouted through an application layer proxy device 410. The application layer proxy device 410 establishes two communication connections, which will be considered to be TCP/IP communication connections for purposes of illustration, although other communication protocols may be used without departing from the spirit and scope of the present invention.

The first TCP/IP connection 420 is established for communicating with the client device. The second TCP/IP connection 430 is established for communication with the server. In establishing a communication connection, the application layer proxy opens kernel sockets to the client and the server, respectively, in a manner generally known in the art.

Each connection 420 and 430 has associated receive and send buffers. The receive buffer 424 receives data packets from the client device and stores the data packets temporarily before they can be transmitted to the server. The send buffer 426 stores address pointers for data packets received from the server that are to be transmitted to the client device. Similarly, the receive buffer 432 receives and stores data packets from the server before they can be transmitted to the client device. The send buffer 436 stores address pointers for data packets received from the client device that are to be transmitted to the server.

Because the present invention maintains two separate TCP connections, one from the application layer proxy to the client and the other from the application layer proxy to the server, features provided by the application layer proxy may be included in the TCP/IP connections. For example, the connection between the client and the application layer proxy will use the features provided by the TCP/IP stack on the client and the application layer proxy. The connection between the application layer proxy and the server will use the features provided by the TCP/IP stack of the application layer proxy and the server.

In the present invention, the kernel of the application layer proxy performs the management operations of the two TCP/IP connections. The kernel of the application layer proxy is able to perform these management operations through a new socket system call function. The one time initial tasks for establishing the connections, such as authentication, connection setup, logging, and the like, may be performed by the application of the application layer proxy in the application space. The application then instructs the kernel to handle management of data movement between the two TCP/IP connections using the socket system call function of the present invention.

For example, a portion of the application's pseudo code may be simplified to:

fd1=accept( ) a connection from client;

fd2=open a new socket;

perform other functions necessary before pushing the rest of the work inside the kernel (e.g., authentication, logging, etc.);

connect(fd2, . . . ) to server;

InKernelDataTransfer(fd1, fd2); /“The new socket system call”/;

close(fd1);

close(fd2);

go back to accepting next connection.

The new socket system call according to the present invention operates to cause the two sockets, i.e. the two TCP/IP connections, to point to one another. This may be done, for example, by implementing a new field in the TCP control block of one socket that points to the other socket's TCP control block. For regular sockets not using the features of the present invention, the new field in the TCP control block will be NULL thereby indicating that the data packet needs to be passed to the user space or routed through the kernel itself.

The TCP control block is created by socket layer services in the kernel when creating a socket for a TCP connection. For example, while an application is creating a socket, the application determines whether the socket will use TCP, UDP or some other transport layer service. The socket layer services in the kernel then create two control blocks—inpcb and tcpcb. The control block inpcb keeps information such as the source and destination IP addresses, TCP or UDP port number of a connection, and the like, which apply to all transport layers. The control block tcpcb maintains information specific to TCP.

In the case of TCP splicing, the application issues a system call splice(so1, so2) where so1 and so2 are the sockets for the connections of the two sides of a proxy. The sockets so1 and so2 are associated with the tcp control block. With the present invention, since TCP splicing is performed at the TCP layer, a new field is provided in the tcp control block. This field in the tcpcb control block of so1 points to the tcp control block of so2. This field in the tcpcb control block of so2 points to the tcp control block of so1. In pseudocode, this splicing of connections may be implemented as:

so1→so_pcb→inp_ppcb→t_spliced_with=so2→so_pcb→inp_ppcb;

and vice versa.

The movement of data packets from one TCP/IP connection to the other may be done by simply moving an address pointer to the data packet from one socket buffer to another. For example, as shown in FIG. 4, if a data packet 450 is being sent from a client device to a server, the data packet is first received and stored in the receive buffer 424 of the first TCP connection 420. The data packet 450 when stored in the receive buffer 424 has a memory address for referencing that data packet 450.

In known systems, in order to move the data packet 450 from the receive buffer 424 to the send buffer 436 of the second TCP connection 430, the application of the application layer proxy must traverse the TCP/IP stack to read the data packet 450 from the receive buffer 424 and then traverse the TCP/IP stack a second time when writing the data packet 450 to the send buffer 436. In the present invention, however, the kernel stores a data packet address pointer 460 that points to the memory address of the data packet in the receive buffer 424.

The data in the socket buffer (whether it be the receive buffer or the send buffer) is managed by keeping the count (in bytes) of the amount of data in the buffer and maintaining a linked list of memory addresses pointing to the data. When data is to be moved from the receive buffer to the send buffer, on the receive side socket the link to this data is removed from the list, and the count is decremented by the size of the data moved. This link is then added to the list on the send side socket and the count on the send side socket is incremented by the size of the data moved.

Because the application kernel according to the present invention manages the TCP connections, there is no need for context switching. Since all data movement operations are performed within the kernel space, there is no need to traverse the boundaries between kernel space and application space. As a result, mapping from one space to another need not be used, thereby resulting in less computational cycles and greater throughput.

When the data packet is to be sent out to the server, the data packet address pointer 460 is accessed and the data packet 450 stored in the receive buffer 424 associated with the data packet address pointer 460 is transmitted to the server. The data packet does not remain in the receive buffer. After the data movement operation, the receive side socket cannot see the data anymore. This same operation is performed using the receive buffer 434 and the send buffer 426.

Thus, the present invention eliminates the need to traverse the TCP/IP stack as well as copy data from one buffer to another. As a result, the speed at which data may be transmitted from a client device to a server and vice versa, via an application layer proxy, is effectively increased.

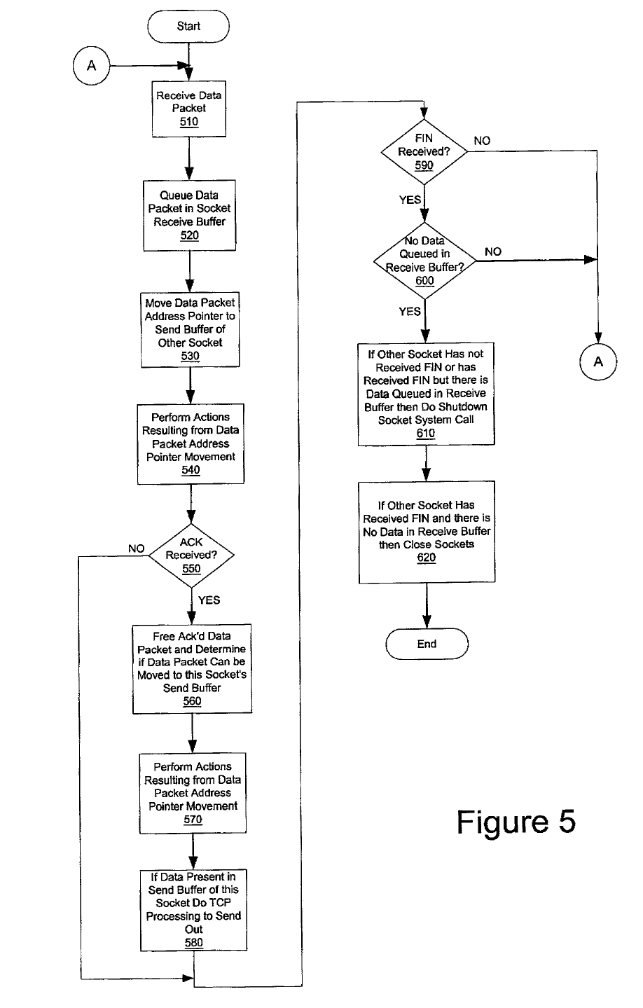

FIG. 5 is a flowchart outlining an exemplary operation of the present invention. The operation described in the flowchart of FIG. 5 is from the viewpoint of the present invention operating on one of the pair of TCP/IP connections.

As shown in FIG. 5, the operation starts with a data packet being received (step 510). The data packet is queued in the socket receive buffer (step 520). The data packet address pointer is moved to the send buffer of the other socket in the manner described above (step 530). Any actions resulting from the movement of the data packet address are then performed (step 540).

A determination is then made as to whether or not an acknowledgment of receipt from the client/server is received (step 550). If so, the acknowledged data packet is freed, i.e. the memory location is set to be overwritten. On freeing the data, the memory occupied by the data is returned to the free or available pool of memory which then becomes available for any other consumer that asks for memory. And a determination is made as to whether a data packet can be moved from the other socket to this socket send buffer queue (step 560). Actions resulting from data packet address pointer movement are then performed (step 570). If data is present in the send buffer of this socket, TCP processing is performed to thereby send the data packet out (step 580).

A determination is then made as to whether a finish indication is received (step 590). If not, the operation returns to step 510 and continues. If so, a determination is made as to whether or not there is data queued in the receive buffer of this socket (step 600). If there is data queued in the receive buffer, the operation returns to step 510. Otherwise, if the other socket has not received a finish indication or has received a finish indication but there is still data queue in its receive buffer, then a shutdown socket system call is made (step 610). If the other socket has received a finish indication and there is no data in its receive buffer, the both sockets are closed (step 620).

Thus, the present invention provides a mechanism by which data packets may be moved between communication connections within the application kernel of an application layer proxy. The present invention eliminates the need for context switching and copying of data packets from one connection to another. As a result, the application layer proxy according to the present invention is capable of higher throughput than known application layer proxies.

Because two separate TCP/IP connections are maintained by the present invention, the two connections can operate under very different networking characteristics and adopt the policies best suited to the particular media. For example, in a wireless/wireline topology, an end-to-end TCP connection may be replaced by two distinct connections meeting at an application layer proxy in accordance with the present invention. One connection may be over the wireless link and the other may be over the wireline link. The features used in the two connections will be those features supported by the two end points and the application layer proxy, respectively.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media such a floppy disc, a hard disk drive, a RAM, and CD-ROMs and transmission-type media such as digital and analog communications links.

The description of the present invention has been presented for purposes of illustration and description, but is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method of moving data from a first communication connection to a second communication connection in an application layer proxy, comprising:
receiving the data in a receive buffer of the first communication connection in the application layer proxy;
generating an address pointer to the data in the receive buffer; and
storing the address pointer in a send queue of the second communication connection in the application layer proxy to thereby move the data from the first communication connection to the second communication connection.

2. The method of claim 1, wherein the generating step is performed within a kernel of the application layer proxy.

3. The method of claim 1, wherein at least one of the first communication connection and the second communication connection is a TCP/IP socket communication connection.

4. The method of claim 1, wherein the first communication connection includes a first kernel socket and the second communication connection includes a second kernel socket.

5. The method of claim 1, wherein the step of generating an address pointer is performed at a TCP layer of a TCP/IP stack of the application layer proxy.

6. The method of claim 1, wherein one of the first communication connection and the second communication connection is between the application layer proxy and a client, and wherein the other of the first communication connection and the second communication connection is between the application layer proxy and a server.

7. The method of claim 2, wherein the steps of generating an address pointer to the data and storing the address pointer in a send queue of the second communication connection in the application layer proxy are performed using a socket system call causing a buffer of the first communication connection to point to a buffer of the second communication connection and the buffer of the second communication connection to point to the buffer of the first communication connection.

8. The method of claim 1, wherein generating an address pointer to the data includes populating a field in a connection control block for the second communication connection to point to a connection control block for the first communication connection.

9. The method of claim 1, wherein the method of moving the data from the first communication connection to the second communication connection is performed without context switching.

10. The method of claim 1, wherein the method of moving the data from the first communication connection to the second communication connection is performed without traversing a boundary between kernel space and application space.

11. The method of claim 1, further comprising:
transmitting the data using the second communication connection by accessing the data identified by the address pointer in the send buffer of the second communication connection.

12. An apparatus for moving data from a first communication connection to a second communication connection in an application layer proxy, comprising:
means for receiving the data in a receive buffer of the first communication connection in the application layer proxy;
means for generating an address pointer to the data in the receive buffer; and
means for storing the address pointer in a send queue of the second communication connection in the application layer proxy to thereby move the data from the first communication connection to the second communication connection.

13. The apparatus of claim 12, wherein the means for generating includes a processor that executes a kernel socket system call.

14. The apparatus of claim 12, wherein at least one of the first communication connection and the second communication connection is a TCP/IP socket communication connection.

15. The apparatus of claim 12, wherein the means for generating an address pointer generates the address pointer at a TCP layer of a TCP/IP stack of the application layer proxy.

16. The apparatus of claim 13, wherein the kernel socket system call causes a buffer associated with the first communication connection to point to a buffer associated with the second communication connection and the buffer associated with the second communication connection to point to the buffer associated with the first communication connection.

17. The apparatus of claim 12, wherein the means for generating an address pointer to the data includes populating a field in a connection control block for the second communication connection to point to a connection control block for the first communication connection.

18. The apparatus of claim 12, further comprising:
means for transmitting the data using the second communication connection by accessing the data identified by the address pointer in the send buffer of the second communication connection.

19. A computer program product in a computer readable medium for moving data from a first communication connection to a second communication connection in an application layer proxy, comprising:
first instructions for receiving the data in a receive buffer of the first communication connection in the application layer proxy;
second instructions for generating an address pointer to the data in the receive buffer; and
third instructions for storing the address pointer in a send queue of the second communication connection in the application layer proxy to thereby move the data from the first communication connection to the second communication connection.

20. The computer program product of claim 19, wherein the second instructions are executed within a kernel of the application layer proxy.

21. The computer program product of claim 19, wherein at least one of the first communication connection and the second communication connection is a TCP/IP socket communication connection.

22. The computer program product of claim 19, wherein the second instructions for generating an address pointer are executed at a TCP layer of a TCP/IP stack of the application layer proxy.

23. The computer program product of claim 19, wherein the second instructions include a socket system call that causes a buffer associated with the first communication connection to point to a buffer associated with the second communication connection and the buffer associated with the second communication connection to point to the buffer associated with the first communication connection.

24. The computer program product of claim 19, wherein the second instructions includes instructions for populating a field in a connection control block for the second communication connection to point to a connection control block for the first communication connection.
